(19) United States
(12) Patent Application Publication
(10) Pub. No.: US 2026/0045723 A1
(43) Pub. Date: Feb. 12, 2026

(54) Electrical Connector

(71) Applicant: Phoenix Contact GmbH & Co. KG, Blomberg (DE)

(72) Inventors: Nathan Lee Potteiger, Middletown, PA (US); Michael Anthony Correll, Hershey, PA (US)

(21) Appl. No.: 18/799,451

(22) Filed: Aug. 9, 2024

(51) Int. Cl. H01R 13/11; H01R 13/635; H01R 24/20

(52) U.S. Cl. CPC H01R 13/11; H01R 13/635; H01R 24/20

(57) ABSTRACT

An electrical connector includes one or more electrical contacts disposed in an insulating body. Each contact is received in a respective contact sleeve of the body. An actuator is disposed in each contact sleeve. The actuator is displaced while inserting an electrical contact into the contact sleeve and returns to an operative position that resists extraction of the inserted electrical contact from the contact sleeve. The actuator can be manually displaced to enable removal of the electrical contact from the contact sleeve.

### FIELD OF THE DISCLOSURE

The disclosure relates generally to electrical connectors, and in particular, to electrical connectors having one or more separate electrical contacts housed in an insulating body.

### BACKGROUND OF THE DISCLOSURE

Electrical connectors having sets of male/female electrical contacts housed in an insulating body are commonly used in pairs to form electrical connections with wire conductors of a multi-conductor cable. The individual electrical contacts of the first electrical connector are typically crimped onto individual conductors of the cable and are then electrically connected to the second electrical connector through the first electrical connector.

The electrical contacts must be crimped onto specific wires of the cable to assure the correct polarity of the electrical connector. If an electrical contact is inadvertently crimped onto the wrong conductor or the electrical contact is placed in the wrong location among plural electrical contacts held in the insulating body, the electrical contact must be removed and a correction made.

It is therefore desirable to provide an electrical connector having one or more separate electrical contacts housed in an insulating body in which an electrical contact can be easily removed from the body.

### SUMMARY OF THE DISCLOSURE

Disclosed is an electrical connection having one or more separate electrical contacts housed in an insulating body in which an electrical contact can be easily removed from the body.

An electrical connector in accordance with this disclosure includes an insulating body having a contact sleeve opening that receives an electrical contact.

The electrical contact is insertable into the contact sleeve opening and movable through the contact sleeve opening in an insertion direction along the contact sleeve opening to an operative position of the electrical contact in the contact sleeve opening with respect to the insulating body.

The electrical connector further includes an actuator. The actuator includes an actuator body and an elastically deformable or deflectable spring member attached to the actuator body. The actuator body is inserted into the insulating body and is receivable through the contact body into the contact sleeve at an insertion location along the contact sleeve axis.

The spring member is configured to engage the insulating body and resist further insertion of the actuator body into the insulating body when the actuator body reaches a first operative position in the insulating body.

The actuator body includes a through-opening at least partially disposed in the contact sleeve opening when the actuator body is in the first operative position.

The electrical contact includes a contact portion extending from a forward end of the electrical contact. The contact portion is configured to pass through the actuator body opening when the electrical contact is inserted into the contact sleeve opening and moves to its operative position in the insulating body.

The contact portion includes a larger outer perimeter portion and a smaller outer perimeter portion extending from the larger outer perimeter portion towards a back end of the electrical contact. The larger outer perimeter portion and the smaller outer perimeter portion can pass through the actuator body opening during insertion of the electrical contact to the operative position of the electrical contact.

The actuator body when in the first operative position is configured to partially obstruct passage of the the larger outer perimeter portion through the actuator body opening. The larger outer perimeter portion is configured to abut against the actuator body and apply a force to the actuator body urging displacement of the actuator body away from the first operative position while the larger outer perimeter portion moves through the actuator body opening. The force elastically deflects the spring member whereby the actuator body moves away from the first operative position to a second operative position in the insulating body while the larger outer perimeter portion passes through the actuator body opening. The deflection of the spring body applies a spring force to the actuator body urging the actuator body towards the first operative position.

The smaller outer perimeter portion of the electrical contact is configured to be spaced away from the second operative position of the actuator body when the smaller perimeter portion begins passing through the actuator body opening. The spring force of the spring member now urges the actuator body from the second operative position towards the first operative position while the smaller outer perimeter portion is in the actuator body opening. The smaller outer perimeter portion is in the actuator body opening when the electrical contact is in the operative position.

When the electrical contact is in the operative position a portion of the actuator body is in the path of movement of the larger outer perimeter portion towards the intake end of the contact sleeve opening and thereby resists movement of the electrical contact from the operative position of the electrical contact towards the intake end of the contact sleeve opening.

To remove the electrical contact from the insulating body, the spring member is manually applied a force (for example, by pressing a screwdriver against the spring member) that urges the actuator body back to at least its second operative position. The electrical connector can then pass through the actuator opening and be removed from the insulating body.

The disclosed electrical connector has the advantage of easy construction and assembly, and easy removal of an electrical contact if necessary.

Other objects and features of the disclosure will become apparent as the description proceeds, especially when taken in conjunction with the accompanying drawing sheets illustrating one or more illustrative embodiments.

### BRIEF DESCRIPTION OF THE DRAWINGS

FIG. 1 is a perspective view of an electrical connector in accordance with this disclosure.

FIG. 2 is an exploded view of the electrical connector.

FIG. 3 is a perspective view of the contact housing of the electrical connector.

FIG. 4 is a sectional view of the contact housing taken along line 4-4 of FIG. 3.

FIG. 4A is an enlarged view of detail 4A shown in FIG. 4.

FIG. 5 is a perspective view of an actuator of the electrical connector.

FIGS. 6-9 are front, top, bottom, and left side views respectively of the actuator.

FIG. 10 is a sectional view of the actuator taken along line 10-10 of FIG. 6.

FIG. 11 is a perspective view of the contact housing with actuators installed.

FIGS. 12-15 are front, top, bottom, and left side views respectively of the contact housing shown in FIG. 11.

FIG. 16 is a sectional view of the contact housing similar to FIG. 4 but with an actuator installed in the contact housing and disposed in a contact sleeve of the contact housing.

FIG. 17 is a longitudinal sectional view of an electrical contact of the electrical connector.

FIG. 18A is a front view of an actuator and FIG. 18B is the longitudinal sectional view of FIG. 16 illustrating the alignment of the actuator with the contact sleeve as viewed in the drawing sheet.

FIG. 19A and FIG. 19B are similar to FIGS. 18A and 18B respectively but with an electrical contact being partially inserted into the contact sleeve.

FIG. 20A and FIG. 20B are similar to FIGS. 19A and 19B respectively but with the electrical contact being further inserted into the contact sleeve.

FIG. 21A and FIG. 21B are similar to FIG. 20A and FIG. 20B respectively with the electrical contact being further inserted into the contact sleeve.

FIG. 22A and FIG. 22B are similar to FIG. 21A and FIG. 21B respectively but with the electrical contact being fully inserted into the contact sleeve.

FIG. 23 is a top view of a lead frame compatible with the electrical connector.

FIG. 24 is a front view of the lead frame.

FIG. 25A illustrates a screwdriver inserted into the slot of an actuator spring member to begin removing an electrical contact from a contact sleeve of the contact housing.

FIG. 25B is an enlarged view of a portion of FIG. 25A.

FIG. 26A and FIG. 26B are similar to FIG. 25A and FIG. 25B respectively but with the screwdriver applying a force to the spring member that displaces the actuator body before initiating removal of the electrical contact.

FIG. 27A and FIG. 27B are similar to FIG. 26A and FIG. 26B respectively but with the electrical contact being partially withdrawn from the contact sleeve.

FIG. 28A and FIG. 28B are similar to FIG. 27A and FIG. 27B respectively but with the electrical contact being fully withdrawn from the contact sleeve and the screwdriver removed away from the spring member.

### DETAILED DESCRIPTION

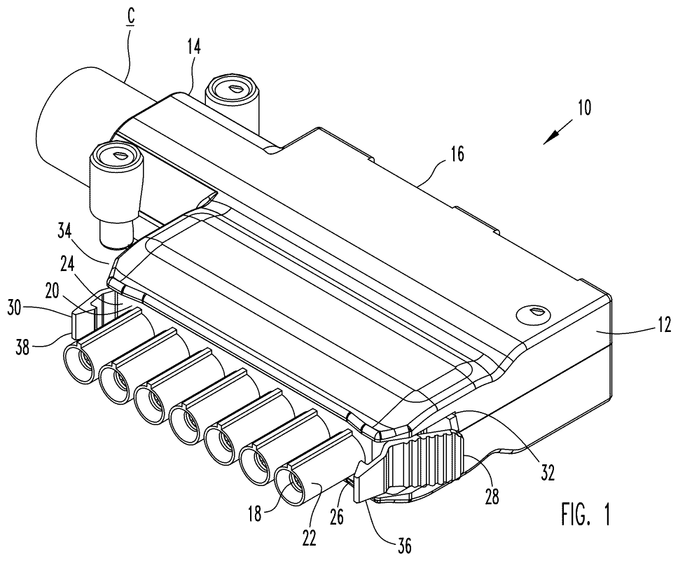

FIG. 1 illustrates an electrical connector 10 in accordance with this disclosure. The electrical connector 10 connects discrete wire conductors of a multi-conductor cable to a number of separate electrical contacts of a second, compatible electrical connector (not shown) to form electrical connections between the wire conductors and the electrical contacts of the second electrical connector.

The electrical connector 10 includes an electrical connector housing 12. The electrical connector housing defines a strain relief area 14 and a contact area 16. The strain relief area 14 receives a multi-conductor cable C into the electrical connector housing. The contact area 16 contains a number of like parallel, electrical contacts formed as elongate socket contacts 18.

The illustrated electrical connector 10 contains like electrically conductive electrical contacts formed as socket contacts 18. The socket contacts are electrically connected to the wire conductors (not shown) of the cable C. The socket contacts 18 are held in an insulating body formed as a contact housing 20 being disposed in the contact area 16. The socket contacts are each received within the bore of a respective tubular opening or contact sleeve 22 defined by the contact housing. The contact sleeves and the socket contacts in the sleeves extend out and away from a front opening 24 of the electrical connector contact area 16.

The contact housing 20 carries a pair of latch assemblies 28, 30 disposed on opposite sides of the contact housing. The latch assemblies extend through opposite side openings 32, 34 of the electrical connector contact area 16 adjacent to the front opening 24. The latch assemblies 28, 30 include movable latch hooks 36, 38 located outside of the electrical connector housing. The latch hooks engage cooperating latching structure of the second electrical connector and releasably maintain mechanical connections between the first and second electrical connectors during use of the electrical connector 10.

When the electrical connector 10 is mechanically connected to the second electrical connector, the socket contacts 18 make electrical contact and continuity with the electrical contacts of the second electrical connector. The electrical connector 10 and the second electrical connector thereby form the electrical connections between the conductors of the cable C and the electrical contacts of the second electrical connector.

FIG. 2 is an exploded view of the electrical connector 10. The connector housing 12 is constructed from an upper or first connector housing member 40 and a lower or second connector housing member 42. The upper and lower connector housing members are releasably fastened together by screws 44 to form the connector housing 12. The housing members cooperatively define a conductor receiving area 46 that receives the cable conductors from the strain area 14 into the contact area 16.

The illustrated electrical connector 10 carries seven (7) like socket contacts 18. Each socket contact 18 extends along a longitudinal axis from a crimp portion 48 at one end of the socket contact to a contact portion 50 on the opposite end of the socket contact. The crimp portion 48 is configured to receive a wire (not shown) of the multi-conductor cable C into the socket contact 18. The crimp portion is crimped onto the wire to create reliable electrical continuity between the wire and the socket contact.

The contact portion 50 of a socket contact 18 is configured as a female contact that receives a contact pin of the second electrical connector into the socket contact. The female contact makes electrical contact with the contact pin inserted into the socket contact. In other possible embodiments of the electrical connector 10 the contact portion 50 is configured as a male contact configured to be received in a female contact of the second electrical connector.

The contact housing 20 positions and locates the socket contacts 18 within the contact sleeves 22. The socket contacts are normally axially fixed relative to the contact housing within the contact sleeves 22. The contact portions 50 of the socket contacts are recessed away from the adjacent open ends of the contact sleeves to resist inadvertent contact with the socket contacts while handling the electrical connector 10 as shown in FIG. 1.

Actuators 52 are located in the contact housing 20. Each actuator is associated with a respective contact sleeve 22 and extends through the contact sleeve as will be discussed in more detail later below. The socket contacts 18 in the contact sleeves 22 extend through the actuators of the assembled electrical connector 10. The actuators are elastically displaceable with respect to the socket contacts to enable removal of an individual socket contact from the contact housing as will be discussed in more detail later below.

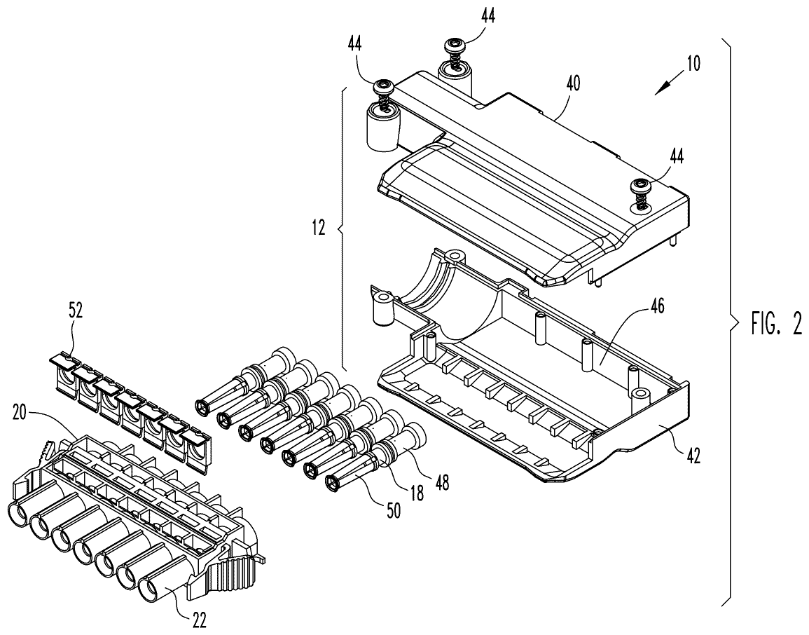

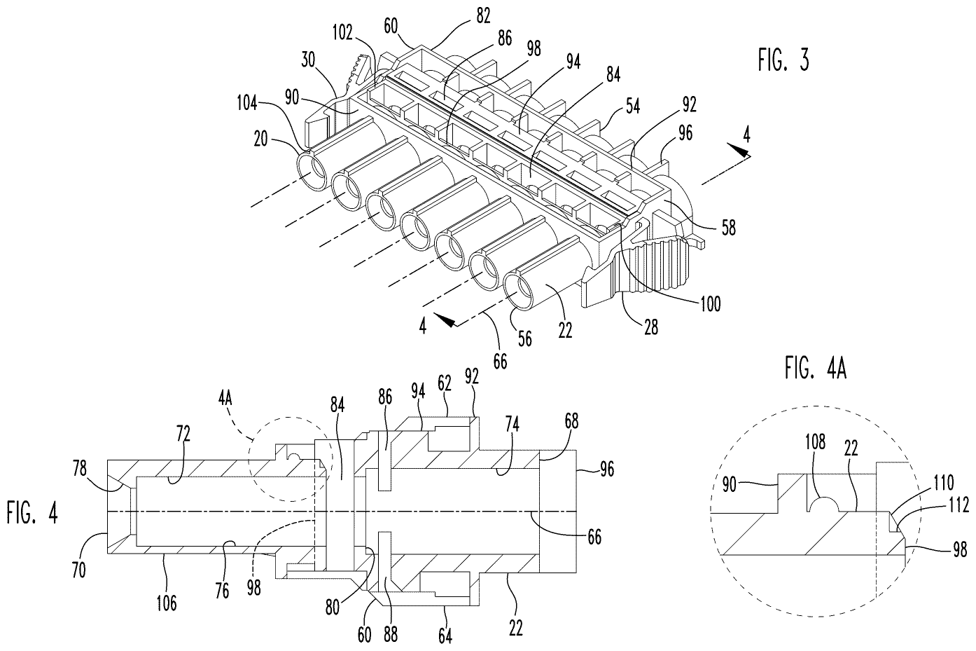

FIG. 3 illustrates the contact housing 20 and the latch assemblies 28, 30 mounted on the contact housing. FIG. 4 is a longitudinal sectional view through one of the contact sleeves 22, it being understood similar sectional views through the other contact sleeves would show the same internal contact sleeve construction.

The contact housing extends in a length direction between a back conductor side 54 and a front contact-receiving side 56. The contact housing extends in a width direction between parallel left and right flat side walls 58, 60 disposed on opposite sides of the contact housing. The latch assembly 28 is mounted on the outside of the side wall 58. The latch assembly 30 is mounted on the outside of the side wall 60. The contact housing extends in a height direction through the thickness of the contact housing between an upper or top side 62 and a lower or bottom side 64 of the contact housing.

The illustrated contact housing defines seven contact sleeves 22 that extend lengthwise along respective sleeve center lines 66. The contact sleeves center lines are evenly spaced apart and locate the socket contacts held in the contact sleeves a predetermined distance apart compatible with the second electrical connector.

Each contact sleeve 22 extends from a conductor side 68 spaced inwardly from the conductor housing back conductor side 54 to a contact-receiving side 70 located on the contact housing front contact-receiving side 56. The contact sleeve has an internal through-bore 72 centered along the contact sleeve's center line 66. The through-bore 72 has an enlarged outer perimeter portion 74, a coaxial reduced outer perimeter portion 76, and a coaxial, generally conical lead-in portion 78 that together combine to extend the full length of the contact sleeve.

The socket contacts 18 are each axisymmetrical about the socket contact centerline. The contact sleeves 22 are also axisymmetrical about the contact sleeve center line 66. In the illustrated embodiment then the enlarged outer perimeter portion 74 and the reduced outer perimeter portion 76 have circular cross-sections with a maximum diameter and a minimum diameter respectively. Alternate embodiments have electrical contacts and corresponding contact sleeves that are not axisymettrical and may have polygonal cross-sections or other cross-section geometry.

The enlarged outer perimeter portion 74 extends away from the conductor side 58 and is configured to receive the crimp portion 48 of a socket contact 18 held in the contact sleeve. The reduced outer perimeter portion 76 extends away from the enlarged perimeter portion and is configured to receive the contact portion 50 of the socket contact. The intake portion 78 opens from the contact-receiving side 70 and reduces in perimeter as it extends to the reduced outer perimeter portion 76. The intake portion guides a contact pin of the second electrical connector received into the contact sleeve towards the sleeve center line.

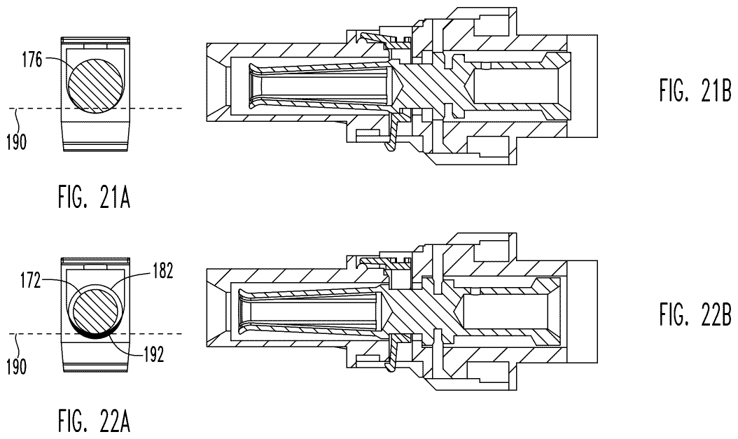

The essentially step transition from the enlarged outer perimeter portion 74 to the reduced outer perimeter portion defines an annular stop surface 80 at the step transition. The stop surface is flat and faces towards the enlarged outer perimeter portion. The stop surface engages and abuts against a cooperating stop surface of a socket contact inserted into the contact sleeve from the conductor side 58. The contact sleeve stop surface and the socket contact stop surface resist further insertion of the socket contact into the contact sleeve and cooperatively define the installed position of the socket contact in the contact sleeve (see also FIG. 22B).

The lead-in portion 78 functions to guide a male contact pin into the contact sleeve 22 for engagement with the socket contact 18.

The contact housing 20 further includes a lattice structure 82 shown in FIG. 3 and FIG. 4. The lattice structure cooperates with the locating structures of the electrical connector housing 12 to position and retain the contact housing in the assembled electrical connector housing.

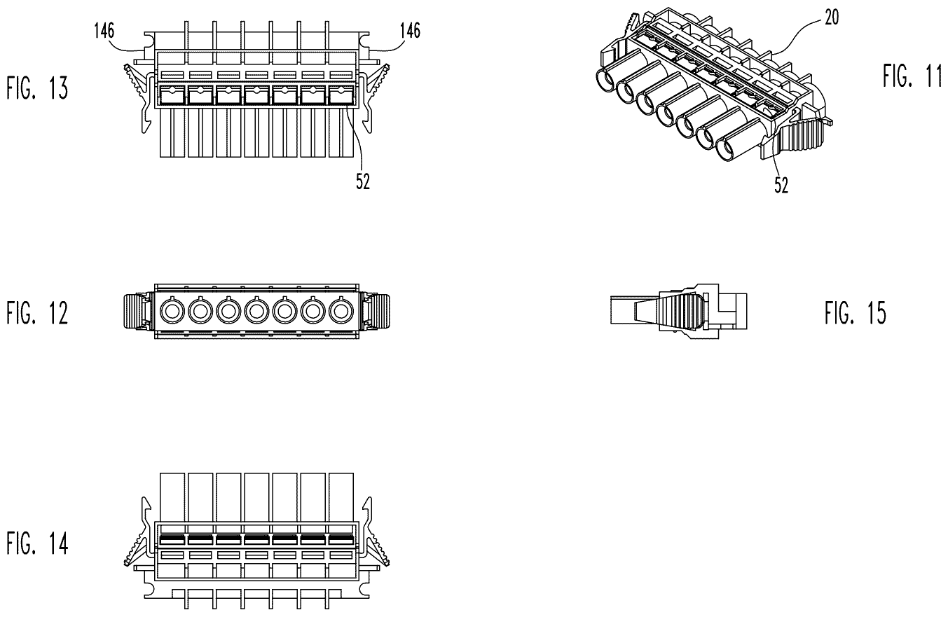

The lattice structure 82 defines a set of seven actuator slots 84 aligned with respective ones of the contact sleeves 22. The actuator slots extend through the thickness of the contact plate and into respective contact slot bores 72. Each actuator slot 84 receives an actuator 52 (see FIG. 11).

The lattice structure 82 also defines a set of seven spaced-apart lead frame slots 86 and a set of seven spaced-apart bottom lead frame slots 88 aligned with the top lead frame slots. The top lead frame slots extend from the top side 62 into respective individual contact slot enlarged outer perimeter portions 74. The bottom lead frame slots extend from the bottom side 64 into respective individual contact slot enlarged outer perimeter portions.

The lattice structure 82 is formed as a matrix of walls that extend the width of the contact housing and walls extending lengthwise from the back conductor side 54 of the conductor housing 20. The lattice structure 82 includes the left side wall 58 and the right side wall 60. The lattice structure further includes a front wall 90, a back wall 92, and an intermediate wall 94 disposed between the front and back walls. The front and back walls extend in the width direction and join the front and back sides respectively of the left and right side walls. The intermediate wall also extends from the left side wall to the right side wall.

The lattice structure includes a set of six (6) equally spaced-apart longitudinal walls 96 that extend lengthwise from the back conductor side 54 of the contact housing 20. The longitudinal walls extend to an auxiliary wall 98. The auxiliary wall is parallel with the front wall 90 and is spaced from the front wall towards the back conductor side of the contact housing. The longitudinal walls are disposed between adjacent pairs of contact sleeves 22 and form portions of the walls of the contact sleeves.

A pair of short longitudinal walls 100, 102 adjacent the left side wall 58 and the right side wall 60 respectively extend away from the intermediate wall 94 and connect to opposite sides of the auxiliary wall 96.

The contact-receiving sides 70 of the contact sleeves 22 are spaced away from the front wall 90. The contact sleeves 22 extend as separate members from their contact-receiving sides 70, through the front wall, and to the auxiliary wall 98. The exposed end portions of the contact sleeves extending away from the front wall include polarization pins 104 that extend lengthwise along the contact sleeves. The outer perimeter of the contact sleeves are enlarged between the front wall and the auxiliary wall as can be seen in FIG. 4.

The reduced perimeter portions 76 of the contact sleeves extend through the front wall and the auxiliary wall, open into the actuator slots 84, and continue into the intermediate wall 94. The enlarged perimeter portions 74 of the contact sleeves continue the conductor sleeve through bores 72 through the intermediate wall 94 and the back wall 92 and into generally tubular portions 106 of the contact sleeves extending from the back wall to the conductor sides 68 of the contact sleeves.

The height of the auxiliary wall 98 is the same as the contact sleeves 22 where the contact sleeves meet the auxiliary wall. Disposed on each of the upper sides of the contact sleeves adjacent the back side of the front wall 90 are arcuate projections 108 that each extend on their uppermost side about halfway from the contact sleeve to the upper end of the front wall. The projections have semi-circular cross-sections as best seen in FIG. 4A.

The auxiliary wall 98, the portions of the longitudinal walls 96 extending from the intermediate wall 94 to the auxiliary wall, the pair of short longitudinal walls 100, 102, and the intermediate wall cooperate to bound and define the actuator slots 84. The auxiliary wall defines and faces flat front sides of the actuator slots. The upper side of the auxiliary wall has respective chamfered edges 110 facing the actuator slots that aid in inserting the actuators into the slots. An indented horizontal surface 112 is formed in each chamfered surface open to the facing aperture slot.

The longitudinal walls define and face flat sides of the actuator slots. The front side of the intermediate wall faces and defines flat back sides of the actuator slots.

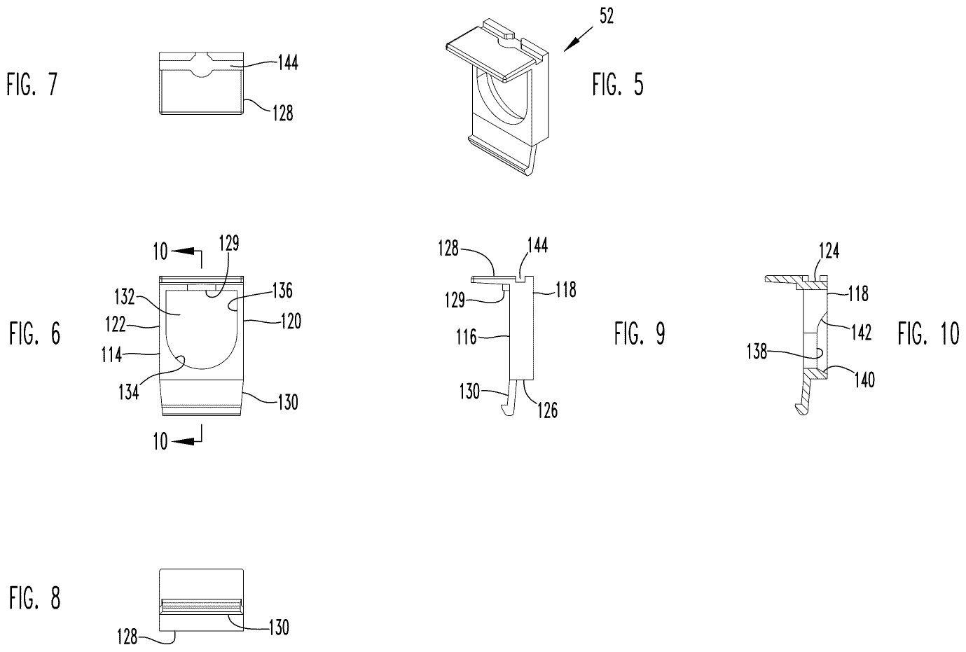

FIGS. 5-10 illustrate an actuator 52 in its normal, unstressed state. The actuator is configured to be held in and operate in an actuator slot of the contact housing.

The actuator has a main body 114 and an elastically deformable or deflectable spring member attached to the spring member. The actuator body is shaped as a generally rectangular plate having flat sides. The actuator body includes a front side 116, an opposite back side 118, a left side 120, a right side 122, a top side 124, and a bottom side 126. The front and back sides are separated by the thickness of the main body. The left and right sides are separated by the width of the main body. The top and bottom sides are separated by the height of the main body.

An elongate, rectangular cantilever beam 128 attached to the main body 114 is located on the top side 124 of the main body. The cantilever beam extends the full width of the main body. The cantilever beam extends away from the front side 116 of the main body to a free end spaced away from the main body.

A stop member 129 is centered on the front side of the actuator top side 124. The stop member 129 extends a short distance away from the actuator front side 116 immediately below the beam 128.

As discussed in more detail below, the cantilever beam 128 in the illustrated embodiment forms the spring member of the actuator 52. The cantilever beam functions as an elastically deflectable or deformable spring that supports the main body 114 in an actuator slot 84. A normal force applied to the beam causes elastic deflection of the beam. The beam deflection enables the actuator to displace along the actuator slot while generating a spring force resisting the displacement. Removal of the normal force allows the spring force to return the main body to its original position in the actuator slot.

A latch hook 130 extends from the bottom side 126 of the main body 114 adjacent to the front side 116 of the main body. The latch hook extends to a free end spaced away from the front side of the main body.

A through-hole 132 extends through the main body 114 normal to the front side 112 and the back side 114 of the main body. The through-hole includes a semi-circular portion 134 adjacent to the bottom side 126 and a constant width portion 136 extending from the semi-circular portion to near the top side 124. The constant width portion extends from the semi-circular portion a distance at least equal to and preferably somewhat greater than the radius of the semi-circular portion.

An intake portion 138 is formed on the back side 118 of the main body 114. The intake portion includes a semi-circular conical portion 142 that extends around the back side of the semi-circular through hole portion 134. The conical portion increases in radius as it extends towards the back side of the main body. A transition portion 142 extends from the semi-circular portion a distance along the constant width through-hole portion 136 that increases in width as it extends towards the back side of the main body.

A slot 144 is formed on the top of the actuator 52 and extends the width of the actuator while centered above the main body 114. The illustrated slot is configured as a screwdriver slot but other slot configurations can be used.

FIGS. 11-15 illustrate the contact housing 20 with the actuators 52 disposed in the actuator slots 84. When the contact housing is housed in the assembled electrical connector housing 12, the electrical connector housing retains the actuators in the actuator slots.

The contact housing 20 includes ears 146 that cooperate with posts located in the electrical connector housing 12 to locate the contact housing in the electrical connector housing during assembly and use of the electrical connector 10. The configuration of the contact housing left side wall 58, right side wall 60, and longitudinal walls 98 also cooperate with the electrical connector housing in locating and fixing the contact housing in the electrical connector housing.

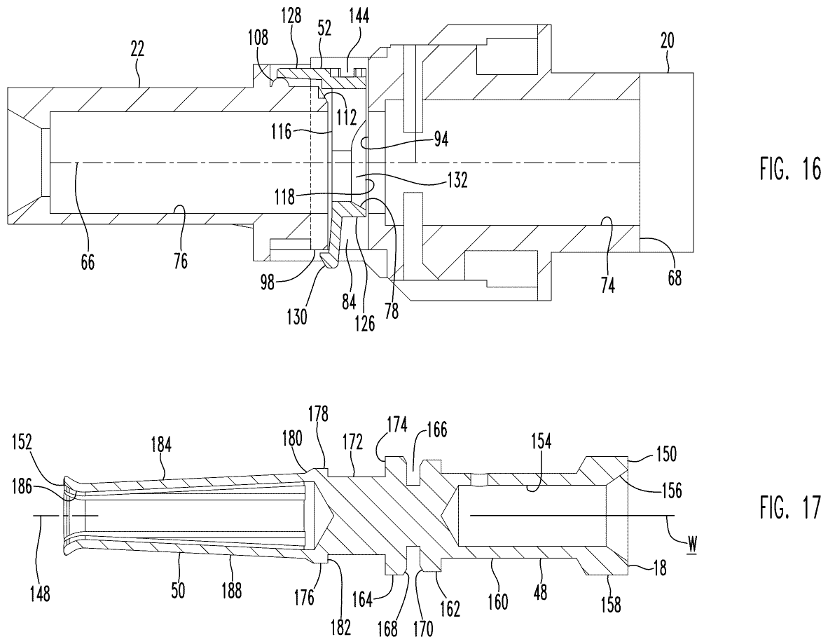

FIG. 16 is a sectional view of the contact housing contact sleeve 22 identical to that of FIG. 4 but including an actuator 52 inserted into the actuator slot 84. The actuator is inserted into the actuator slot from the top side of the actuator slot. The actuator is inserted with the latch hook 130 leading into the actuator slot. The actuator slides down the actuator slot until the actuator beam 128 engages and abuts the top of the rounded projection 108 of the contact housing 20 disposed on the contact sleeve. The projection resists further insertion of the actuator and locates the actuator in its inserted first operative position in the actuator slot at an insertion location along the contact sleeve axis. The beam is closely received between the respective left and right longitudinal walls of the actuator slot. The beam extends over the top of the auxiliary wall 98 to reach the projection 108.

During insertion, the actuator main body 114 is closely received into the actuator slot 84. The actuator front side 116 is parallel with and closely faces the contact housing auxiliary wall 98. The actuator back side 118 is parallel with and closely faces the intermediate wall 94. The actuator left and right side walls 120, 122 are parallel with and closely face respective left and right longitudinal walls of the actuator slot. The walls closely receive the actuator body and guide displacement of the of the actuator body along the slot.

The actuator latch hook 130 during actuator insertion is initially pushed back by the chamfered surface 112 from its unstressed state into the actuator slot 84. The elastic deflection of the latch hook generates a spring force pressing the latch hook against the auxiliary wall 98. With continued insertion of the actuator 52, the head of the latch hook moves out from the bottom side of the actuator slot 84. The latch hook returns to its unstressed state whereby the latch hook moves over and overlays the bottom side of the auxiliary wall 98. The latch hook resists movement of the actuator towards the upper end of the actuator slot, resisting any ability of the actuator to fall out of the actuator slot when the actuators are not restrained inside the assembled connector housing 12.

FIG. 16 illustrates the actuator 52 in its first operative position in the actuator slot 84. The actuator (including the actuator beam 128) is in essentially an unstressed state as shown in FIG. 5 (force generated by the weight of the actuator is ignored). The actuator is in a neutral position with respect to the contact sleeve center line 66. The sides of the actuator slot allow substantially only translation of the actuator body 114 along the actuator slot, and resists any substantial rotation of the actuator body in the actuator slot.

The screwdriver slot 144 is accessible to a screwdriver if the contact housing 20 is removed from the electrical connector 12 or if the upper electrical connector housing member 40 is removed from the electrical connector.

The actuator through-hole 132 as shown in FIG. 16 is inserted into and aligned with the reduced perimeter portion 76 of the contact sleeve 22. The conical intake portion 78 faces towards the conductor side 68 of the contact housing 20. The conical intake portion faces towards the conductor side 68 of the contact sleeve 22. The portion of the actuator extending along the actuator bottom side 126 partially blocks the contact sleeve reduced perimeter portion as shown in FIG. 16.

FIG. 17 is a sectional view of a socket contact 18. The socket contact is shown on the drawing sheet as if vertically displaced from its inserted position in the contact sleeve 22 as viewed in FIG. 16 on the same drawing sheet to show relative axial alignment of cooperating features of the contact sleeve and socket contact. The illustrated socket contact can be considered axially symmetric (axisymmetric) about the contact center line 148 (that is, the socket contact does not have to be inserted into the contact sleeve with a predetermined angular orientation with respect to the contact sleeve center line to operate as a socket contact).

The socket contact 18 extends in a forward direction along the socket contact center line 148 from a back conductor end 150 to a front contact end 152. The socket contact crimp portion 48 extends from the conductor end and is axially symmetric about the socket contact center line. The socket crimp portion is formed with a conductor receiving bore 154 formed as a blind hole. The socket contact is crimped and compressed about a conductor end W of the cable C (shown representationally in FIG. 17) to electrically connect the conductor and the socket contact.

The blind hole 154 has a conical, chamfered conductor lead-in opening 156. The lead-in opening is formed in a radially-enlarged end collar 158 at the back conductor end. A reduced perimeter portion 160 extends from the end collar to the closed end of the conductor receiving bore 154.

A forward collar 162 and an intermediate collar 164 are located at the forward end of the socket crimp portion 48. Both collars 162, 164 are axially forward of the conductor receiving bore 154 and are axially spaced apart from one another. The forward collar defines the forward end of the socket crimp portion. The intermediate collar also has the same outer diameter as the end collar 158. The intermediate collar and the end collar are sized to be closely received in the enlarged outer perimeter portion 74 of a contact sleeve. The intermediate collar and the end collar cooperate to maintain the inserted socket contact 18 substantially centered in the contact sleeve.

The forward collar 164 has a slightly reduced outer diameter as compared to the intermediate collar 164. The space between the forward collar and the intermediate collar defines an annular air gap 166 between the forward collar and the intermediate collar. Formed on the facing sides of the forward collar and intermediate collar are respective chamfered annular surfaces 168, 170.

A coupling portion 172 of the contact socket 18 extends axially forward from the forward collar 162. The coupling portion has a uniform outer diameter that is sized to be received with some radial clearance in the reduced outer perimeter portion 76 of a contact sleeve 22.

The step reduction in perimeter from the forward collar 162 to the coupling portion defines an exposed, annular forward-facing stop surface 174 extending radially from the bridging portion to the outer perimeter of the forward collar.

The stop surface 174 abuts against the facing annular stop surface 80 of a contact sleeve 22 during insertion of the contact socket into the contact sleeve. The socket contact stop surface cooperates with the contact sleeve stop surface to resist further insertion of the socket contact into the contact sleeve, thereby defining the inserted position of the socket contact in the contact sleeve.

Disposed at the forward end of the coupling portion 172 is a radially-enlarged actuator collar The actuator collar extends from the coupling portion to the socket contact contact portion 50. The actuator collar includes a uniform outer perimeter portion 178 adjacent the coupling portion and a conical or reducing outer perimeter portion 180. The conical portion extends from the uniform perimeter portion to the socket contact contact portion 50 and reduces in outer diameter as it extends to the socket contact contact portion.

The uniform perimeter portion 178 has a step increase in perimeter from the coupling portion 172. The step increase defines an exposed, annular back-facing stop surface 182 extending radially from the coupling portion to the outer perimeter of the actuator collar. The actuator collar stop surface 182 faces the forward collar stop surface 174. The stop surfaces 182, 174 are spaced apart by the coupling portion.

As will be described in more detail below, the actuator collar stop surface 182 functions as an abutment surface that faces a closely adjacent actuator inserted into the contact sleeve that receives the socket contact 18. The actuator collar stop surface is just forward of the actuator and engages the actuator to resist relative translation of the socket contact in the extraction direction towards the conductor receiving side 68 of the contact sleeve.

The actuator collar conical portion 180 uniformly decreases in perimeter as it extends axially from the uniform perimeter portion 178 to the outer surface of the socket contact contact portion 50.

The illustrated socket contact contact portion 50 is formed as a female contact having four like, closely adjacent elongate contact arms 184. The contact arms cooperate to define a conical shaped lead-in 186 and a conical body 188 extending from the lead-in to the actuator collar 176. The conical body smoothly and uniformly increases in perimeter as it extends to the actuator collar.

FIGS. 18a-22a and 18b-22b illustrate sequentially the insertion of a socket contact 18 into a contact sleeve 22. The socket contact as shown in the figures as being inserted with the socket contact center line 148 (see FIG. 17) being coaxial with the contact sleeve center line 66 (see FIG. 16).

A socket contact 18 that receives a conductor of the cable C has been crimped onto the conductor prior to insertion. For drawing clarity and simplicity, a conductor is not shown in the figures.

A socket contact not receiving a conductor of the cable C is inserted as shown in the figures. The contact socket may be electrically connected to a socket contact by a lead frame after the contact sockets are inserted into the contact housing.

Each pair of associated FIGS. (18A, 18B), (19A, 19B), . . . (22A, 22B) illustrate the relative position of the actuator 52 with respect to the contact sleeve 22. The actuator in the “A” figure is a front view of the actuator as shown in sectional side view in the adjacent “B” figure. The broken horizontal line 190 in FIG. 18A is tangent with the bottom of the actuator semi-circular portion 134 when the actuator is in its neutral position as shown in FIG. 18B. The horizontal line remains fixed relative to the contact sleeve in the other FIGS. 19A, 20A, 21A, and 22A. Translation of the actuator in the actuator slot 84 can be seen from displacement of the actuator relative to the horizontal line in the “A” figures and by the gap between the latch hook 130 and the bottom side of the auxiliary wall 98.

FIGS. 18A and 18B show the actuator 52 inserted into the actuator slot 84 before insertion of a socket contact. The actuator in its neutral position with the dashed line 190 tangent with the bottom of the semi-circular through-hole portion 134.

FIGS. 19A and 19B show the socket contact 18 being partially inserted into the contact sleeve 22. The socket contact is shown with the with socket contact conical lead-in or bell mouth 186 coming into engagement with the conical intake portion 134 of the actuator 52. The bell mouth applies a downward force component to the intake portion 134. This force component is transferred to the actuator beam 128, causing elastic deflection of the actuator beam 128 that results in a downward translation of the actuator body 114. The translation of the actuator body enables the socket contact to clear the obstruction presented by the actuator and pass through the actuator opening 132.

The translation of the actuator body is relatively small as shown in FIGS. 19A and 19B. If the socket contact were not radially centered in the contact sleeve, the socket contact lead-in could contact the actuator intake portion closer to the back side of the actuator, or might pass through the actuator through hole 134 without engaging the socket contact lead-in.

FIGS. 19A and 19B illustrate further insertion of the socket contact 18 into the contact sleeve 22. The socket contact lead-in 186 has passed through the actuator 52 and the socket contact contact body 188 is passing through the actuator.

Immediately after the socket contact lead-in passed the actuator, the spring force applied by the actuator beam 128 to the actuator body 114 enabled the actuator to return to its neutral, first operative position in the actuator slot 84.

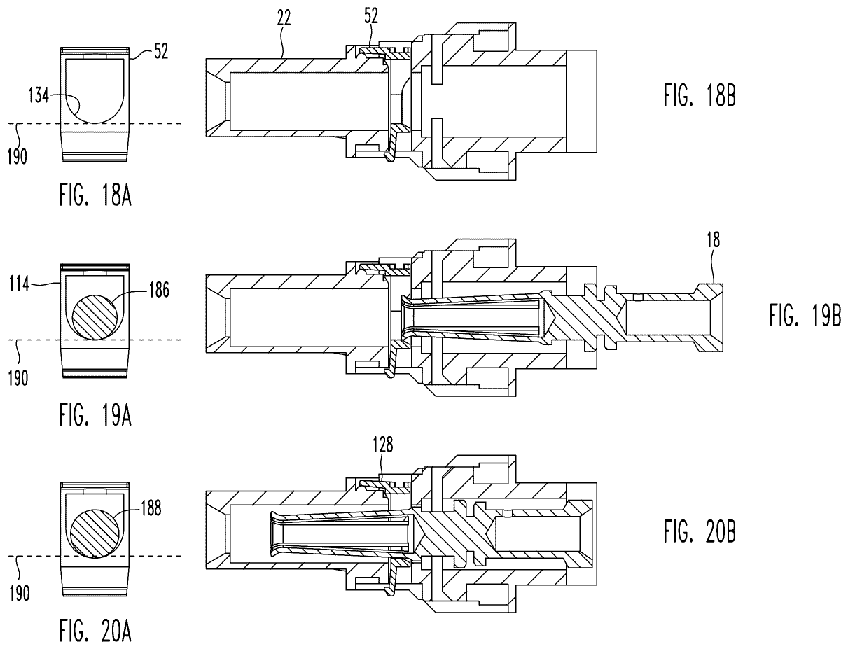

FIGS. 20A and 20B shows continued movement of the socket contact 18 into the contact sleeve 22. The bottom side of the conical contact body 188 of the socket contact causes the bottom side of the contact body to engage against the lower portion of the actuator body that defines the semi-circular opening 134. In response the actuator beam 128 deflects downwardly, enabling the actuator body 114 to translate downwardly. Deflection of the actuator enables the contact body to pass through the actuator through-hole 132.

Bending deflection of the actuator beam 128 relative to the actuator body 114 can be clearly seen in FIG. 20B. The free end of the actuator beam is supported against the rounded contact sleeve projection 108 that allows the beam to bend downwardly as the beam extends from the projection towards the actuator body. The top side 124 of the actuator body moves towards the indented surface 112 of the contact sleeve 22.

FIGS. 21A and 21B show the socket contact actuator collar 176 passing through the actuator 52 with continued insertion of the socket contact 18 into the contact sleeve 22. The actuator collar has the largest outer diameter and is the largest outer perimeter portion of the socket contact that must pass through the actuator during insertion of the socket contact. The actuator collar sloping portion 180 forces the maximum downward translation of the actuator body 114 to a second operative position displaced from the first operative o position. This generates the maximum deflection of the actuator beam 128 during insertion of the socket contact, and enables the actuator to receive the actuator collar uniform outer perimeter portion 178.

Both the forward collar 162 and the end collar 158 are received inside the contact sleeve enlarged perimeter through-bore portion 74. This minimizes possible misalignment of the socket contact 18 along the contact sleeve center line 66 while the socket contact actuator collar 176 is moving through the actuator 52. Minimizing misalignment reduces any additional deflection and resulting additional generated stress of the actuator body 114 needed to accommodate socket contact misalignment as the socket contact actuator collar moves past the actuator.

FIGS. 22A and 22B illustrate the socket contact 18 fully inserted into the contact sleeve 22. The socket contact forward collar stop surface 174 faces the contact sleeve stop surface 80. Further displacement of the socket contact 18 in the insertion direction is resisted by the cooperating abutment of the socket contact stop surface 174 against the contact sleeve stop surface 80.

The socket contact actuator collar 176 has moved past the actuator 52. The coupling portion 172 is now passing through the actuator. Immediately after the actuator collar 176 clears the actuator, the spring force generated by the maximally deflected actuator beam 128 quickly moves the actuator body 114 upwardly in translation from the second operative position towards the first operative position and towards the bottom side of the coupling portion. The actuator perimeter wall bounding the actuator through-hole semi-circular portion 134 is now closely spaced from the socket contact coupling portion 172.

During insertion of the socket contact 18 as shown in FIGS. 18A-22B, passage of the actuator collar 176 and the coupling portion 172 cooperate to force displacement of the actuator body to permit the actuator collar to pass through the actuator opening that generates a spring force that returns the actuator body back to its first operative position when the coupling portion 172 starts passing through the actuator opening. The actuator collar defines a larger outer perimeter portion of the socket contact and the coupling portion defines an adjacent smaller outer perimeter portion of the socket contact that cooperate to enable the actuator body to obstruct and resist extraction of the socket contact from the contact sleeve after being inserted into the contact sleeve.

The socket contact actuator stop surface 182 is shown in phantom relative to the actuator 52 in FIG. 22A. The socket contact actuator stop surface faces the front side 116 of the actuator 52. An area portion 192 (the area filled in black in FIG. 22A) of the socket contact actuator stop surface faces a corresponding solid surface on the front side of the actuator.

Attempted displacement of the socket contact 18 from its inserted position in an extraction direction opposite the insertion direction (by, for example, inserting a contact of the second electrical connector into the socket contact) is resisted by the area portion 192 engaging against the actuator front surface. Axial displacement of the actuator in the extraction direction is resisted by the actuator slot back wall 92.

The outer perimeter of the coupling portion 172 is sized to enable the actuator to return to its neutral, unstressed state at its first operative position as seen in FIG. 18B (or alternatively to a low stress state) when the socket contact 18 is fully inserted into the contact sleeve. The actuator is not stressed or is lightly stressed during normal operation of the electrical connector 10.

The socket contact gap 166 between the socket contact forward collar 162 and the intermediate collar 164 is aligned with both the top lead frame slot 86 and the bottom lead frame slot 88 associated with the contact sleeve. A lead frame inserted into either lead frame slot makes electrical contact with the portion of the socket contact facing the air gap between the forward collar and the intermediate collar. The lead frame is configured to electrically connect the socket 18 with one or more of the other contact sockets of the electrical connector 10.

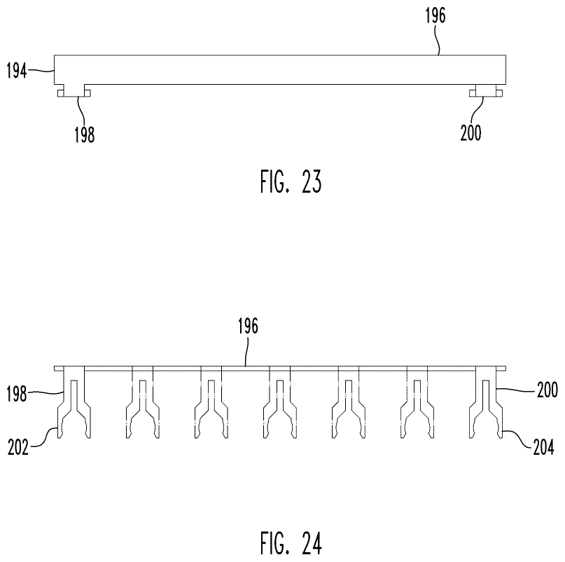

FIGS. 23 and 24 illustrate a lead frame 194 designed for the electrical connector 10. The illustrated lead frame has a flat body 196 and a pair of arms 198, 200 on opposite ends of the body. The arms extend downwardly from the lead frame body to respect end contacts 202, 204. Each end contact is configured to receive and make electrical connection with the socket contact when the arms are received into the top lead frame slot 86 or bottom lead frame slot 88. The lead frame body rests against the top of the contact housing when the end contacts are inserted into the lead frame slots. The lead frame is retained against the contact housing by the electrical connector housing 12 during use.

The illustrated lead frame 194 is designed to place the contacts into the pair of lead frame slots adjacent the opposite sides of the contact housing. The lead frame can include additional end contacts (shown in phantom lines in FIG. 24) to simultaneously connect additional socket contacts. Lead frames can be designed to span between adjacent pairs of socket contacts, between pairs of socket contacts with one socket contact, and the like.

The illustrated sets of contact housing top and bottom lead frame slots 86, 88 are vertically aligned with one another. In other embodiments of the contact housing, the sets of top and bottom lead frame slots can be axially offset from one another to engage a contact socket at axially spaced-apart locations on the contact socket.

It may be discovered that after a socket contact has been inserted into a contact sleeve, the socket contact must be removed. For example, the socket contact may have been placed in the wrong contact sleeve or a wire crimp is not making reliable contact.

FIGS. 25a-28a and 25b-28b illustrate extraction of an inserted socket contact 18 from the contact sleeve 22. It has already been confirmed that power to the socket contact has been removed before initiating socket contact extraction from the contact sleeve.

The socket contact 18 is crimped onto a conductor before being inserted into the contact sleeve. For drawing clarity and simplicity, the conductor and the crimped connection is not shown in the figures.

Each pair of associated FIGS. (25A, 25B), . . . (28A, 28B) illustrate in the “A” figure the contact sleeve and in the “B” figure an enlarged portion of the contact sleeve showing the actuator in the contact sleeve. The contact housing has been removed from the electrical connector housing to enable access to the actuator and removal of the socket contact from the contact housing. The actuator is manually actuated using a screwdriver to manually translate the actuator along the actuator slot to enable extraction of the socket contact.

FIGS. 25A and 25B show the socket contact 18 fully inserted into the contact sleeve 22. The actuator 52 is in the extraction path of movement of the socket contact stop surface 182 and resists extraction of the socket contact as previously described. To initiate extraction, a screwdriver S is inserted into the actuator screwdriver slot 144. The screwdriver will be pressed against the actuator to manually actuate the actuator. FIGS. 25A and 25B illustrate the actuator 52 prior to actuation.

FIGS. 26A and 26B show the screwdriver S pressing down on the screwdriver slot 144. The force exerted by the screwdriver elastically deflects the actuator beam 128 and translates the actuator body 114 downwardly along the actuator slot 84. Deflection of the actuator beam 128 is limited by the actuator stop member 119 abutting against the contact sleeve indented surface 112 located in the path of movement of the actuator stop member.

As shown in FIGS. 26A and 26B, the actuator 52 in its displaced position is in a position deflected just beyond that shown in FIG. 21. The entire socket contact actuator collar 176 now faces the actuator through-hole 132. The actuator no longer obstructs movement of the socket contact in the extraction direction.

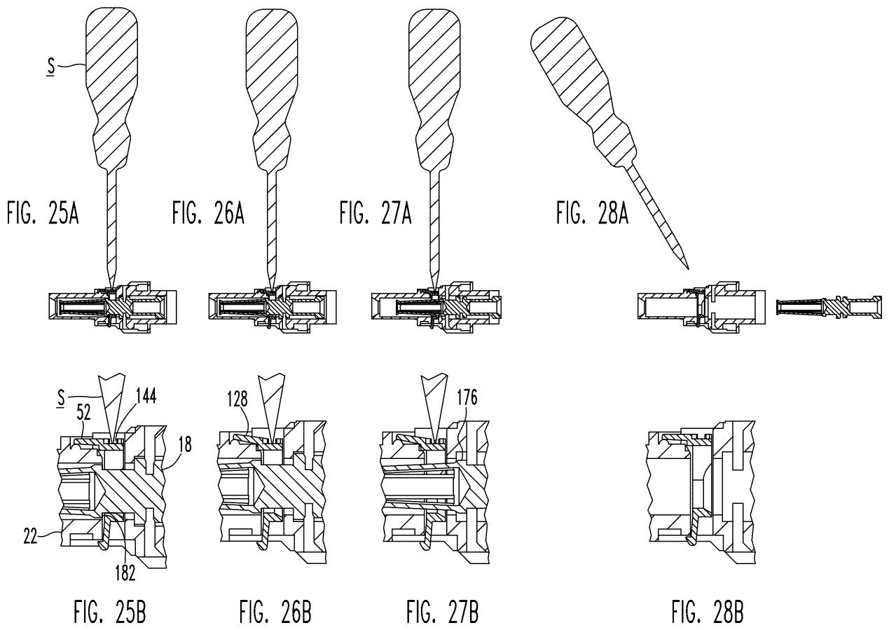

FIGS. 27A and 27B show partial extraction of the socket contact 18. The screwdriver S continues to apply force to the actuator 52 maintaining the actuator in its displaced position. The socket contact actuator collar 176 has passed through the actuator and the socket contact contact portion 50 has passed part-way through the actuator.

FIGS. 28A and 28B show the socket contact 18 fully extracted from the contact sleeve 22. The screwdriver S is removed from the actuator screwdriver slot 144. With the screwdriver force removed, the actuator 52 elastically returns to its unstressed neutral position as also shown more clearly in FIG. 16. A contact socket can then be re-inserted into the contact sleeve 22 as described previously.

While this disclosure includes one or more illustrative embodiments described in detail, it is understood that the one or more embodiments are each capable of modification and that the scope of this disclosure is not limited to the precise details set forth herein but include such modifications that would be obvious to a person of ordinary skill in the relevant art including (but not limited to) changes in material selection, size, operating ranges (voltage and power ratings of the contact sockets and the electrical connector as a whole), socket contact configuration (for example, male or female socket contact), capability to jump two or more socket contacts, environment of use, number and arrangement of socket contacts and contact sleeves, wiring configuration of the socket contacts of the electrical connection (for example, which conductor is ground or is neutral), and the like, as well as such changes and alterations that fall within the purview of the following claims.

What is claimed is:

1. An electrical connector comprising:
an insulating body comprising a contact sleeve opening extending along an axis from an intake end of the contact sleeve opening into the insulating body;
an electrically conductive electrical contact, the electrical contact extending along an axis from a forward end of the electrical contact to an axially opposite back end of the electrical contact, the electrical contact being receivable into the contact sleeve opening and movable in the contact sleeve opening in an insertion direction and an opposite extraction direction, the forward end of the electrical contact being insertable into the contact sleeve opening and movable through the contact sleeve opening in the insertion direction along the contact sleeve opening axis from the contact sleeve opening to an operative position of the electrical contact in the contact sleeve opening with respect to the insulating body;
an actuator, the actuator comprising an actuator body and an elastically deflectable or deformable spring member attached to the actuator body, the actuator body being insertable into the insulating body and being receivable through the contact body into the contact sleeve at an insertion location along the contact sleeve axis, the spring member being configured to engage the insulating body and resist further insertion of the actuator body into the insulating body when the actuator body reaches a first operative position in the insulating body, the spring member being in an relaxed operating state when the actuator body is in the first operative position;
the actuator body comprising a through-opening at least partially disposed in the contact sleeve opening when the actuator body is in the first operative position;
the electrical contact comprising a contact portion extending along the electrical contact axis from the forward end of the electrical contact, the contact portion being configured to pass through the actuator body opening when the electrical contact moves in the contact sleeve opening from the intake end of the contact sleeve opening to the operative position;
the contact portion comprising a larger outer perimeter portion and a smaller outer perimeter portion extending from the larger outer perimeter portion towards the back end of the electrical contact, the larger outer perimeter portion and the smaller outer perimeter portion being configured to pass through the actuator body opening of the electrical contact from the intake end of the contact sleeve opening to the operative position of the electrical contact;
the actuator body when in the first operative position being configured to partially obstruct passage of the the larger outer perimeter portion through the actuator body opening, the larger outer perimeter portion being configured to abut against the actuator body and apply a force to the actuator body urging displacement of the actuator body away from the first operative position of the actuator body while the larger outer perimeter portion moves through the actuator body opening during insertion of the electrical contact, the force elastically deflecting the spring member whereby the actuator body moves away from the first operative position to a second operative position in the insulating body while the larger outer perimeter portion passes through the actuator body opening, the deflection of the spring body applying a spring force to the actuator body urging the actuator body towards the first operative position;
the smaller outer perimeter portion of the electrical contact being configured to be spaced away from the second operative position of the actuator body when the smaller outer perimeter portion begins passing through the actuator body opening wherein the spring force of the spring member urges the actuator body from the second operative position towards the first operative position while the smaller outer perimeter portion is in the actuator body opening, the smaller outer perimeter opening being in the actuator body opening when the electrical contact is in the operative position;
wherein when the electrical contact is in the operative position a portion of the actuator body in the second operative position is in the path of movement of the larger outer perimeter portion towards the intake end of the contact sleeve opening and thereby resisting movement of the electrical contact from the operative position of the electrical contact towards the intake end of the contact sleeve opening.

2. The electrical connector of claim 1 wherein the actuator body moves away from the spring member when moving from the first operative position to the second operative position.

3. The electrical connector of claim 1 wherein the spring member is a cantilever beam extending from the actuator body to a free end portion of the cantilever beam spaced away from the actuator body.

4. The electrical connector of claim 3 wherein the free end portion of the cantilever beam engages an arcuate surface of the insulating body to resist further insertion of the actuator body into the insulating body.

5. The electrical connector of claim 1 wherein the electrical contact when moving in the contact sleeve opening to the operative position of the electrical contact abuts against the insulated housing to resist further movement of the electrical contact past the operative position.

6. The electrical connector of claim 1 wherein the spring member is externally accessible with respect to the insulating body when the actuator body is in the first operating position wherein an external force may be manually applied to the spring member that is transmitted to the actuator body urging the actuator body to or beyond the second operating position.

7. The electrical connector of claim 1 wherein the spring member comprises a slot formed thereon that is externally accessible with respect to the insulating body when the actuator body is in the first operating position whereby an external force may be manually applied to the spring member by a tool inserted into the slot that is transmitted to the actuator body urging the actuator body to or beyond the second operating position.

8. The electrical connector of claim 1 wherein the larger outer perimeter portion of the electrical contact comprises a uniform outer perimeter portion and a reducing outer perimeter portion extending from the uniform outer perimeter portion towards the forward end of the electrical contact wherein the reducing outer perimeter portion reduces in outer perimeter as the reducing perimeter portion extends away from the uniform outer perimeter portion.

9. The electrical connector of claim 8 wherein the contact sleeve opening extends through the insulating body to a second opening in the insulating body opposite the intake opening; and
the electrical contact comprises a female contact portion disposed at the forward end of the electrical contact, the female contact portion being configured to receive a portion of a male electrical contact received through the second opening when the electrical contact is in the operative position in the contact sleeve opening.

10. The electrical connector of claim 9 wherein the female contact portion comprises a bell mouth at the forward end of the electrical contact, the bell mouth defining a reducing opening extending away from the forward end of the electrical contact to a minimum opening of the bell mouth, the bell mouth being configured to apply a force to the actuator body that urges the actuator body from the first operating position towards the second operating position should the bell mouth engage against the actuator body during insertion of the electrical contact into the contact sleeve opening.

11. The electrical connector of claim 10 wherein the bell mouth has a maximum outer perimeter that is less than the maximum perimeter portion of the electrical contact, the female contact portion extends towards the back end of the electrical contact to the maximum perimeter portion, and the outer perimeter of the female contact portion increases in outer perimetas the female contact portion extends from the bell mouth towards the maximum diameter portion.

12. The electrical connector of claim 1 wherein the spring member and the insulating body are configured to limit deflection of the spring member by the deflected spring member abutting the insulating body when the actuator body has moved from the first operative position to the second operative position or beyond the second operative position.

13. The electrical connector of claim 1 wherein the reduced perimeter portion of the electrical contact is a uniform perimeter portion.

14. The electrical connector of claim 1 wherein the larger perimeter portion of the electrical contact comprises an annular surface surrounding the reduced perimeter portion where the reduced perimeter portion extends from the larger perimeter portion; and
the actuator body in the second operative position is configured to engage the annular surface and thereby obstruct movement of the electrical contact from the operative position towards the towards the contact sleeve intake opening.

15. The electrical connector of claim 1 wherein the larger perimeter portion and the reduced perimeter portion of the electrical contact are each axisymmetric about the longitudinal axis of the electrical contact.

16. The electrical connector of claim 1 wherein the actuator body comprises a semi-circular first edge bounding a portion of the actuator opening and uniformly spaced apart second and third edges extending from opposite sides of the first edge towards the spring member.

17. The electrical connector of claim 16 wherein the first edge forms a conical portion of the actuator body that faces and extends towards the intake end of the contact sleeve opening when the actuator body is in the first operating position, the conical portion increasing in radius as it extends towards the intake end of the contact sleeve opening.

18. The electrical connector of claim 1 wherein the actuator body is a rectangular plate.

19. The electrical connector of claim 18 wherein the insulating body has a slot that extends into the actuator body from a first open end to at least the contact sleeve opening, the slot being defined by a wall of the actuator body that surrounds the slot, the slot closely receiving the actuator body when the actuator body is inserted into the insulating body, the wall guiding movement of the actuator body along the slot when the actuator body moves in the slot between the first operating position and the second operating position.

20. The electrical connector of claim 19 wherein the slot of the insulating body slot extends to an opposite second open end, and the actuator comprises a latch arm that extends out of the second open end when the actuator body is in the first operating position, the latch arm being configured to resist extraction of the inserted actuator body through the first open end of the slot.

21. The electrical connector of claim 1 wherein the contact sleeve opening is one of a plurality of like contact sleeve openings of the insulating body, the electrical connector is one of a plurality of like electrical connectors, and the actuator is one of a plurality of like actuators, each electrical connector of the plurality of electrical connectors and each actuator of the plurality of actuators being associated with a respective contact sleeve opening of the plurality of contact sleeve openings.
